(19) United States
(12) Patent Application Publication
(10) Pub. No.: US 2010/0199211 A1
(43) Pub. Date: Aug. 5, 2010

(54) ITEM SETTING DEVICE, CONTROL METHOD AND CONTROL PROGRAM FOR THE DEVICE

(75) Inventors: Shin IGAWA, Tokyo (JP); Seiji Harada, Tokyo (JP); Rei Yokoyama, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/693,678

(22) Filed: Jan. 26, 2010

(30) Foreign Application Priority Data
Jan. 28, 2009 (JP) JP2009-017058

(51) Int. Cl. G06F 3/048

(52) U.S. Cl. 715/777

(57) ABSTRACT

The display information is compared with the displayed information on what items are already displayed at what positions on the editable tab screen capable of editing the items stored therein, wherein the aforementioned display information includes the display item information on which of the items contained in the fixed tabs are to be displayed on the editable tab screen and the display position information on the positions of the items to be found on the editable tab screen. If a change has been discovered, a step is taken to determine the method of change processing for displaying the editable tab screen according to the result of comparison. The editable tab screen selected by the user is displayed according to the method of change processing based on the result of comparison.

This application is based on Japanese Patent Application No. 2009-017058 filed on Jan. 28, 2009 with Japanese Patent Office, the entire content of which is hereby incorporated by reference.

### BACKGROUND OF THE INVENTION

The present invention relates to an item setting device, and the control method and program for the device. The present invention particularly relates to an item setting device for setting based on user operations for an item which is displayed on a switchable screen that can be changed by selecting a desired tab out of a plurality of tabs, and the control method and program for the device.

In a printing system, when a user performs printing using a printer, the user sets each setting item to a desired setting value on a PC (personal computer) using a control program called the printer driver, and sets the print conditions, whereby the printing operation is performed by the printer. As the capabilities of the printer are enhanced to permit various forms of print conditions to be set, the number of setting items tends to increase in a printer driver.

Thus, a plurality of setting items are classified according to related functions, and are associated by tabs, whereby the visibility and maneuverability of the printer driver are being improved. In this case, when the user sets the desired print conditions, the user selects a tab and changes the operation screen so that a desired setting item may be displayed and the setting item is set (changed), according to the conventional method.

Thus, when the user has to change a plurality of setting items associated with different tabs to set the print conditions, the print condition setting work is complicated.

In one of the techniques proposed against this background, the mutual setting items which have inherently different attributes and cannot be shifted can be freely replaced as the setting items desired by the user, and the user can freely update the design of the screen containing the setting items having different attributes (Japanese Patent Application Publication No. Hei 11 (1999)-53137).

However, if the user carries out a design change on a screen on which a held item can be edited, when displaying the updated screen, a problem is predicted that the update of the screen display takes a long time. For example, even only addition of a single item or change of the display position of an item causes a problem of consuming a long time for re-display of the entire screen from the beginning and a poor operability of the user.

The present invention has been achieved to solve the abovementioned problems and an object of the present invention is to provide an item setting device which can quickly display a screen of editable tab on which items can be edited even when the screen has been updated, and a control method and control program for the device.

### SUMMARY

To achieve at least one of the abovementioned objects, an item setting device reflecting one aspect of the present invention comprises the followings.

(1) An item setting device which conducts setting based on operation of a user, for items which are displayed on a screen which can be switched by selecting a desired tab from a plurality of tabs with the item setting device including an item information holding section which holds item information relating to display of fixed items of a fixed tab, a fixed tab display control section for controlling to display a screen of the fixed tab selected by the user by using the item information of the fixed tab, a display information holding section which holds display information including display item information relating to which items held in the fixed tabs are to be displayed on a screen of an editable tab having the items which can be edited and display position information relating to display positions of the items to be displayed on the screen of the editable tab, a displayed information holding section for holding displayed information about which items have been already displayed and which positions on the screen of the editable tab the items have been displayed at, a display item comparison processing section which compares the display information and the displayed information, and determines a change processing method for displaying the screen of the editable tab based on a result of the comparison if a change is found, and an editable tab display control section for controlling to display the screen of the editable tab selected by the user according to the change processing method based on the result of the comparison.
(2) The item setting device of the above item (1), wherein the display item comparison processing section determines deletion, shift display or addition display for each item based on the result of the comparison.
(3) The item setting device of the above item (1), wherein the editable tab display control section controls to display the screen of the editable tab according to the displayed information, if no change is found when comparing the display information with the displayed information and the screen of the editable tab is not currently displayed.
(4) The item setting device of the above item (1), wherein the display position information can be edited by the user.
(5) The item setting device of the above item (1), wherein the item is for setting a print condition.

### BRIEF DESCRIPTION OF THE DRAWINGS

FIG. 1 is a block diagram representing the overall structure of a printing system in an embodiment of the present invention.

FIG. 2 is a block diagram representing the structure of the PC shown in FIG. 1.

FIG. 3 is a diagram showing the basic structure of a printer driver.

FIG. 4 is a flow chart showing the procedure of display processing on the print setting screen.

FIG. 5 is a diagram showing an example of item information.

FIG. 6 is a diagram showing an example of a fixed tab screen.

FIG. 7 is a diagram showing an example of an editability list.

FIG. 8 is a diagram showing an example of a group information list.

FIG. 9 is a table showing the information on each setting item.

FIG. 10 is a diagram showing an example of an edit screen.

FIG. 11 is a diagram showing the case where a screen edit instruction is given directly on the editable tab screen.

FIG. 12 is a diagram showing the case where the edit instruction of the editable tab screen is given on the fixed tab screen.

FIG. 13 is a diagram showing an example of the display item list.

FIG. 14 is a flow chart representing the procedure of display processing of the editable tab screen.

FIG. 15 is a flow chart representing the procedure of display processing according to the result of the comparison.

FIG. 16 is a diagram showing an example of the displayed information table.

FIG. 17 is a diagram showing an example of the display item list after the edition.

FIG. 18 is a diagram showing an example of the comparison result.

FIG. 19 is a diagram showing an example of the updated displayed information table.

FIG. 20 is a diagram showing an example of the editable tab screen displaying the state of the display item list in FIG. 13.

FIG. 21 is a diagram showing an example of the editable tab screen on which the state of the display item list of FIG. 17 having been edited is displayed after the state of the display item list of FIG. 13 has been displayed.

### DETAILED DESCRIPTION OF THE PREFERRED EMBODIMENTS

Referring to the drawings, a preferred embodiment of the present invention will be detailed in the following.

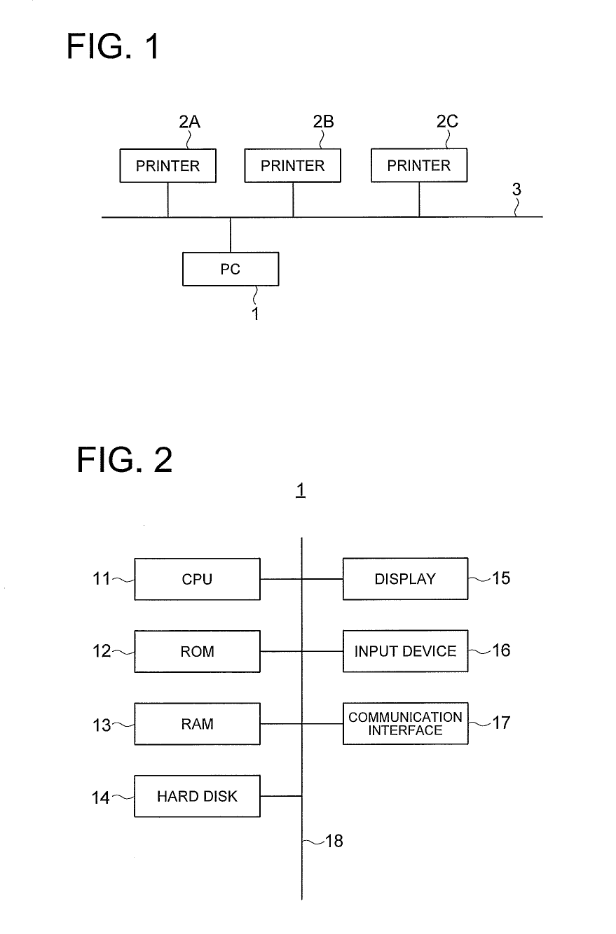

FIG. 1 shows a block diagram indicating an overall configuration of a printing system embodied in the present invention.

As shown in FIG. 1, the printing system embodied in the present invention is constituted by a PC1 (Personal Computer 1), printers 2A, 2B and 2C, which are communicatively coupled to each other through a network 3. In this connection, the number of apparatuses and kinds of apparatuses, which are to be coupled to the network 3 are not limited to those shown in FIG. 1. Further, it is also applicable that the PC1 is directly coupled to the printers 2A, 2B and 2C without employing the network 3 (local connection).

For instance, the network 3 is composed of various kinds of networks such as a LAN (Local Area Network) in which computers and networking apparatuses are coupled to each other based on the specifications complying with Ethernet, the token ring, the FDDI (Fiber Distributed Data Interface) for example, and a WAN (Wide Area Network) in which plural LANs are coupled to each other through an exclusive communication line.

FIG. 2 shows a block diagram indicating a configuration of the PC shown in FIG. 1. The PC1 is provided with a CPU (Central Processing Unit) 11, a ROM (Read Only Memory) 12, a RAM (Random Access Memory) 13, a hard disk 14, a display 15, an input device 16 and a communication interface 17, which are coupled to each other through a bus 18 for transacting signals between them.

The CPU 11 executes control for abovementioned sections and various kinds of computational processing according to programs. The ROM 12 stores various kinds of programs and various kinds of data therein. The RAM 13 serves as a working area to temporarily store the programs and the data. Further, the hard disk 14 stores various kinds of programs including an operating system (OS) and various kinds of data, therein.

The display section 15 is constituted by a CRT (Cathode Ray Tube) or an LCD (Liquid Crystal Display) or the like so as to display various kinds of information thereon. The input device 16 includes a pointing device such as a mouse, and a keyboard, which are used for conducting various kinds of input operations.

The interface section 17 serves as an interface for communication with the other apparatuses, including the printers 2A, 2B and 2C through the network 3. Local connection interfaces including network interfaces which comply with a standard such as the Ethernet, the token ring and the FDDI, a serial interface such as the USB (Universal Serial Bus) and the IEEE1394, a parallel interface such as the SCSI (Small Computer System Interface) and the IEEE1284, a wireless interface including the Bluetooth (Registered Trademark), the IEEE802.11, the HomeRF (Home Radio Frequency) and the IrDA (Infrared Data Association), and the telephone line interface for connecting to the telephone line can be employed as the interface section 17.

Further, an application program for creating a document file and the printer driver are installed in advance into the hard disk 14. The printer driver is employed not only for setting the printing conditions based on the operations conducted by the user using a print setting screen to be detailed later, but also for creating a print job in such a format that is processable for the printers 2A, 2B and 2C, based on document file given by the document file creating application program.

The PC1 may include other components than the aforementioned ones, or may not include some of the aforementioned components.

Through the network 3, the printers 2A, 2B and 2C receive the printing job created by the PC1, and perform printing processing according to the printing job.

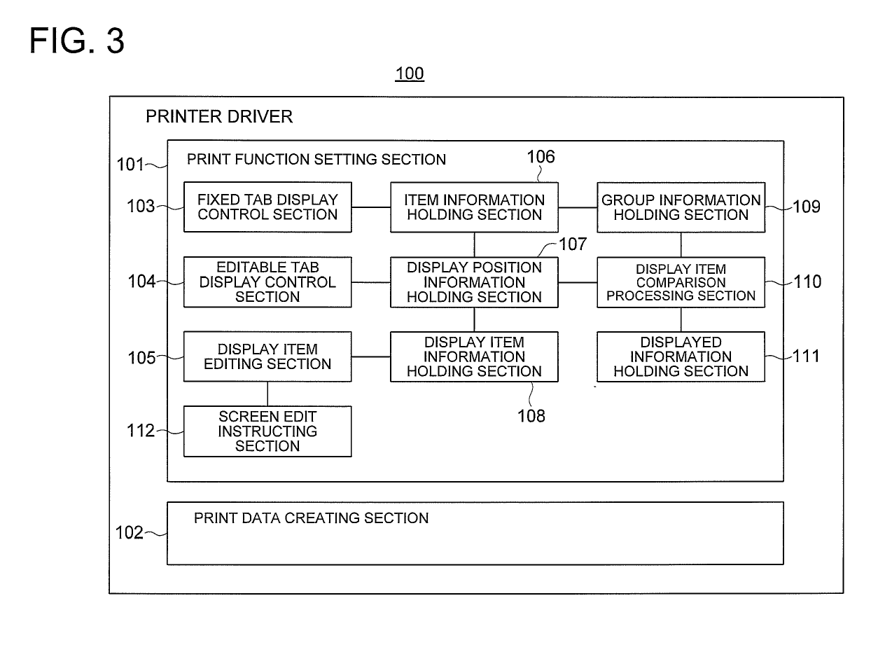

FIG. 3 is a diagram showing the basic structure of a printer driver.

The printer driver 100 is software that is installed on the OS of the PC1 as a host computer, and creates a printing job. Through the user interface, the printer driver 100 enables a user to conduct setting for using the function mounted on the corresponding printer. According to the setting, a printing job in the format that can be processed in the printers 2A through 2C can be created and sent to the printer.

The printer driver 100 includes a print function setting section 101 and print data creating section 102.

The print function setting section 101 provides a screen (GUI) that permits the user to set up desired print conditions. Fixed tabs having the fixed items whose display positions are fixed, and an editable tab permitting editing of the possessed items wherein the display position of the items can be edited are displayed on the screen displayed by the printer driver 100 of this embodiment in such a way that these tabs can be selected by the user. If the editable tab has been selected by the user, the screen associated with the editable tab (editable tab screen) is displayed. If one of the fixed tabs has been selected by the user, the screen associated with the selected fixed tab (fixed tab screen) is displayed. The information set on the screen is handed over to the print data creating section 102.

Based on the document file created by the application installed on the OS, the print data creating section 102 creates the printing job in the format that can be processed in the printers 2A through 2C.

As shown in FIG. 3, the print function setting section 101 includes an item information holding section 106, fixed tab display control section 103, display item information holding section 108, display position information holding section 107, displayed information holding section 111, display item comparison processing section 110, editable tab display control section 104, display item editing section 105, screen edit instructing section 112 and group information holding section 109.

The item information holding section 106 holds the item information on the display of the items registered in the fixed tab. To put it more specifically, the item information is the information for each item (also referred to as “control”) as exemplified by information for an ID, type (text, radio button, check box, image and others), display position (coordinate), size of the display area (length and width) and line of characters to be displayed.

The fixed tab display control section 103 provides control for reading the item information of the fixed tab and displaying a specific fixed tab screen.

The display item information holding section 108 holds the display item information about which item of the items held by the fixed tab should be displayed on the editable tab screen.

The display position information holding section 107 holds the display position information on the display position of the item to be displayed on the editable tab screen. Here, the display item information and the display position information constitute display information.

A displayed information holding section 111 holds displayed information about which item has been already displayed and which position on the editable tab screen the item has been displayed at.

A display item comparison processing section 110 compares display information with displayed information, and when a change is found, determines a change processing method for displaying the editable tab screen based on the comparison result.

An editable tab display control section 104 controls the display of the editable tab screen. Further, the editable display control section 104 controls to display the editable tab screen according to the determined change processing method when a change is found between the display information and the displayed information.

The display item editing section 105 performs editing operations such as addition, shift and deletion of the item to be displayed on the editable tab screen. To put it more specifically, the display item editing section 105 edits the item displayed on the editable tab screen, and the display position.

The screen edit instruction section 112 receives the user's instruction for editing the item to be displayed on the editable tab screen. When the user gives an instruction to change the item displayed on the editable tab screen and the display position, the screen edit instruction section 112 gives a screen editing instruction to the display item editing section 105.

For all the items displayed by the printer driver, the group information holding section 109 holds the group information indicating the group of the setting item (function) to which the item belongs. In this case, the setting item is made up of a plurality of items (controls).

The functions of the print function setting section 101 and print data creating section 102 are fulfilled when the program stored in the hard disk 14 is read out onto the RAM 13 and is executed by the CPU 11. A predetermined storage area is assigned to each of the item information holding section 106, display item information holding section 108, display position information holding section 107, and group information holding section 109.

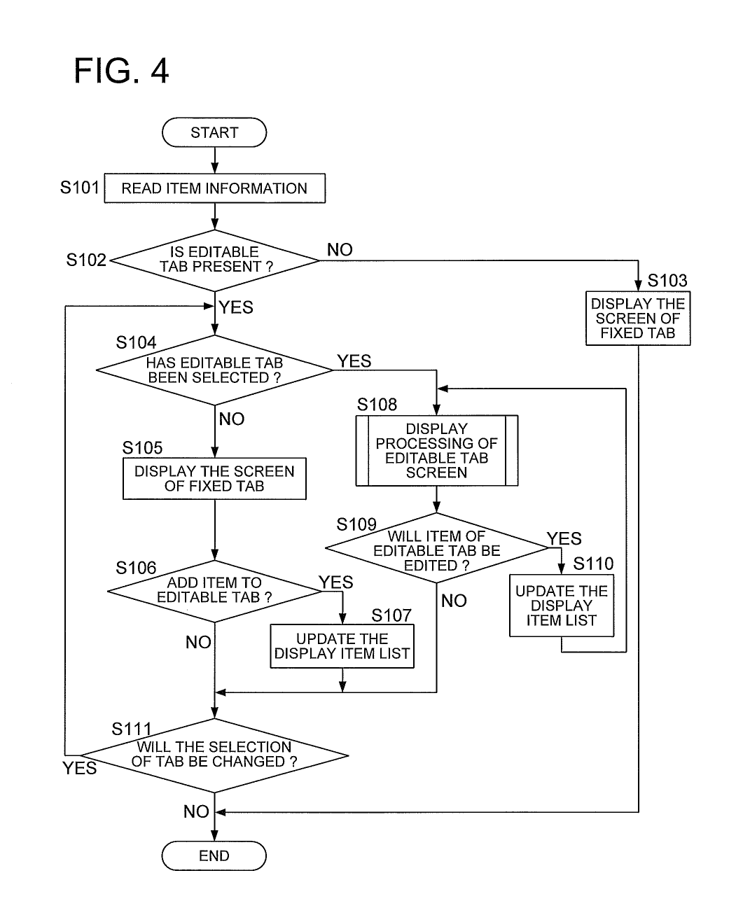

Referring to FIG. 4, the following describes the operation of the print function setting section 101.

FIG. 4 is a flow chart showing the procedure for display processing of the print setting screen.

In the first place, the item information on the fixed tab is read (S101).

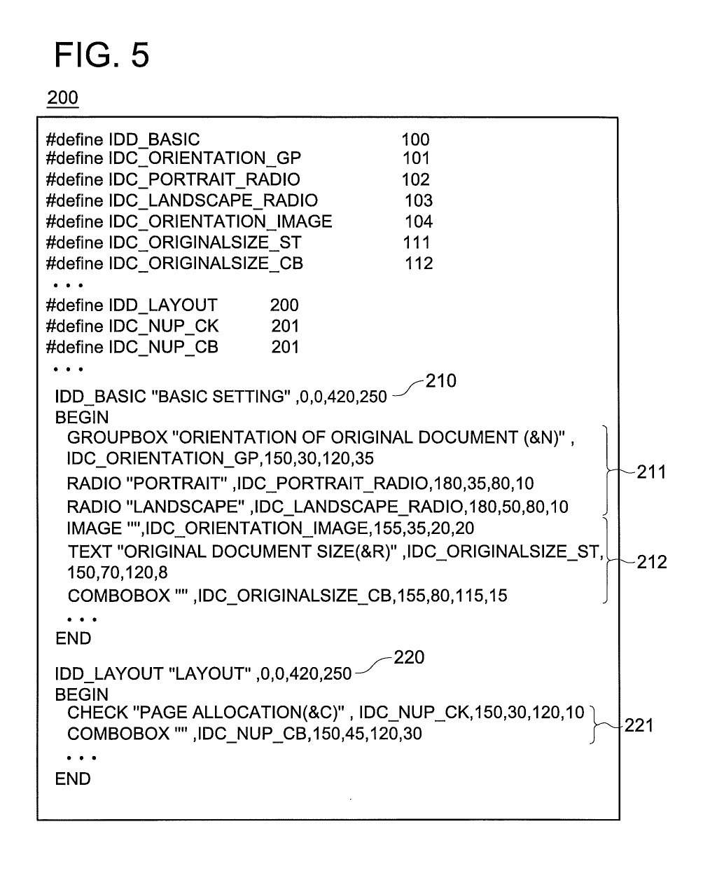

FIG. 5 is a diagram showing an example of item information. In this case, the “basic setting” tab information 210 and “layout” tab information 220 are exemplified as a part of the item information. Further, the “basic setting” tab information 210 includes the “original document orientation” information 211 and “original document size” information 212. The “layout” tab information 220 includes the “page allocation” information 221.

The detailed information of the item information can be possessed as one file or can be possessed as different plural files. Further, all of the item information can be stored in a registry, or a part of the item information can be stored in a file different from the registry while another part of the item information is stored in the registry.

In the next step, a decision is made to see whether the editable tab is present or not (S102).

The setting of whether the editable tab is present or not is carried out at the time of developing the printer driver. Not only that, this setting can also be adjusted by the user (or administrator). If the setting is carried out at the time of developing the printer driver in such a way that there is no editable tab, the printer driver includes only fixed tabs (as is the case with the conventional printer driver). In the printer driver including an editable tab, if the setting is made by the user in such a way that the printer has no editable tab, the editable tab is not displayed on the screen.

If there is no editable tab (S102: NO), the fixed tab screen is displayed based on the item information having been read (S103).

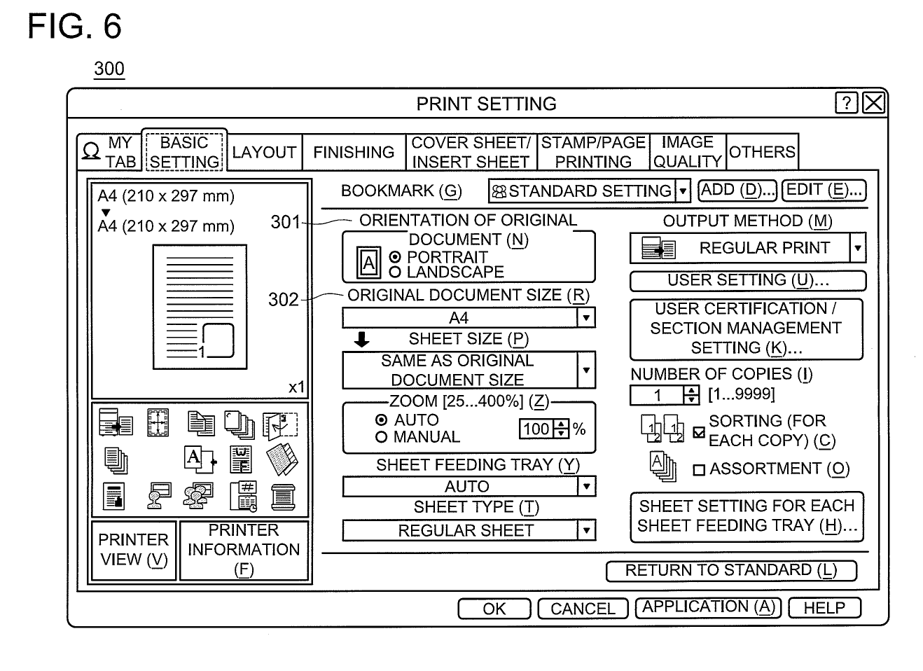

If the editable tab is present (S102: YES), a step is taken to determine whether or not the editable tab (shown as “My tab” in FIG. 6) has been selected (S104).

In the printer driver 100 of the present embodiment, the setting is made so that the editable tab may be first displayed at the time of startup, with consideration given to convenience. It is also possible to arrange the setting in such a way that the fixed tab will be first displayed.

If the fixed tab is selected without the editable tab being selected (S104: NO), the fixed tab screen is displayed using the item information having been read (S105).

FIG. 6 is a diagram showing an example of a fixed tab screen 300.

In FIG. 6, the basic setting tab screen is being displayed according to the “basic setting” tab information 210 of the item information 200 (FIG. 5). For each setting item, the “original document orientation” 301 is displayed according to the “original document orientation” information 211 of the item information 200, and the “original document size” 302 is displayed according to the “original document size” information 212 of the item information 200.

When the editable tab has been selected (S104: YES), display processing of the editable tab screen is performed (S108). In this case, the editable tab screen is displayed collectively for each group. Display processing of the editable tab screen will be described in detail later.

In Step S109, a decision is made to see whether or not the printer operation has been made to edit the item to be registered in the editable tab.

When the editable tab screen is to be terminated without the editable tab item being edited (S109: NO), a step is taken to determine whether or not the tab selection has been changed by the user (S111).

When the tab selection has been changed (S111: YES), the operation goes back to the processing of S104.

When the tab selection is not changed (S111: NO), the processing in FIG. 4 is terminated by the user operation such as the end of setting, cancel of setting, or start of printing.

When there is an editable tab, the item to be displayed on the editable tab screen can be added or edited by registration in the editable tab (S106, S109).

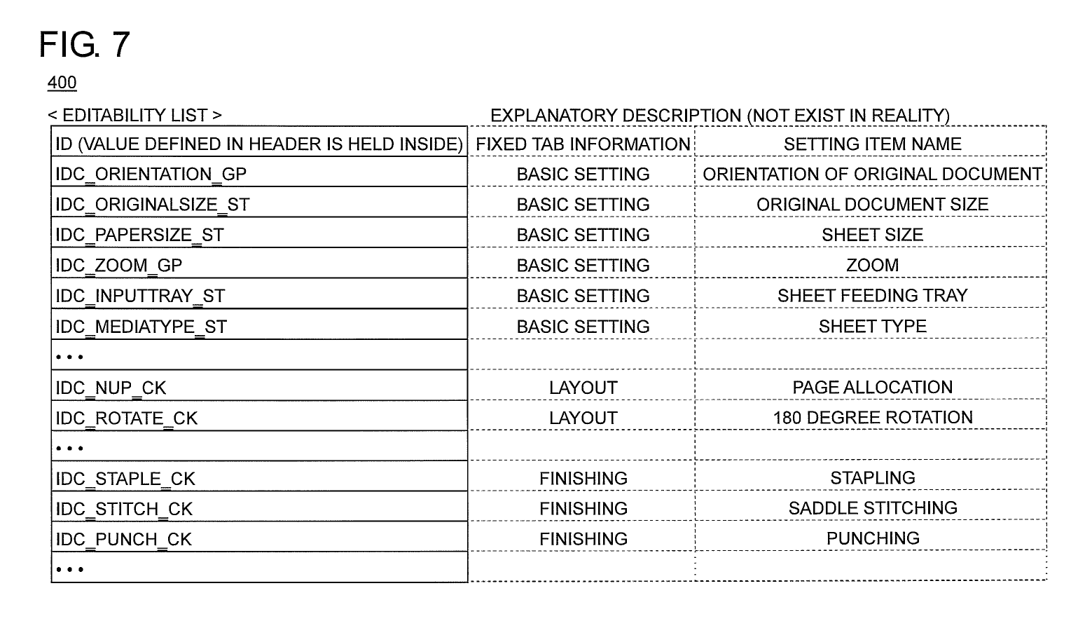

FIG. 7 is a diagram showing an example of the list (editability list) for all the items that can be registered in the editable tab. This editability list 400 does not include items common to all the tabs (such as sheet view) or items specific to the fixed tab. The description in the broken line frame shown on the right side of FIG. 7 is given for the purpose of explanation, and does not indicate substantial data. (This also applies to the description in the broken line frame appearing in the subsequent diagrams).

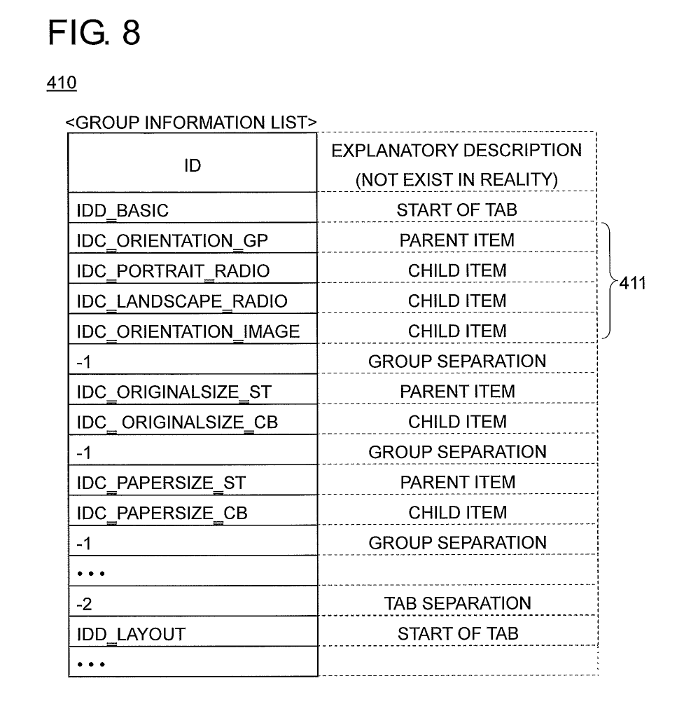

FIG. 8 shows an example of the list of the group information (group information list) showing the group of the setting items to which each of a plurality of items (control) belongs. For example, as indicated by the reference numeral “411” in the group information list 410 of FIG. 8, the setting item for “original document orientation” 301 (FIG. 6) is made up of a plurality of items such as a group box, two radio buttons, and image. To be more specific, one setting item can be said to consist of a group of a plurality of items. In order to handle a plurality of items having unity in terms of functions as a group in this manner, in the present embodiment, the item representative of the group, i.e., the parent item of the group is determined, and setting items are handled in groups using the parent item. For example, for the setting items of the “original document orientation” 301 of FIG. 6, the “original document orientation” group box is the parent item. For the setting items of the “original document size” 302, the “original document” size text is the parent item (FIG. 5).

In the following description, the name of the setting items as a group (ID is described by means of the parent item) is mentioned. In this case, all the items in the group are processed at the same time. The group information list 410 could be incorporated in the aforementioned item information 200 or editability list 400.

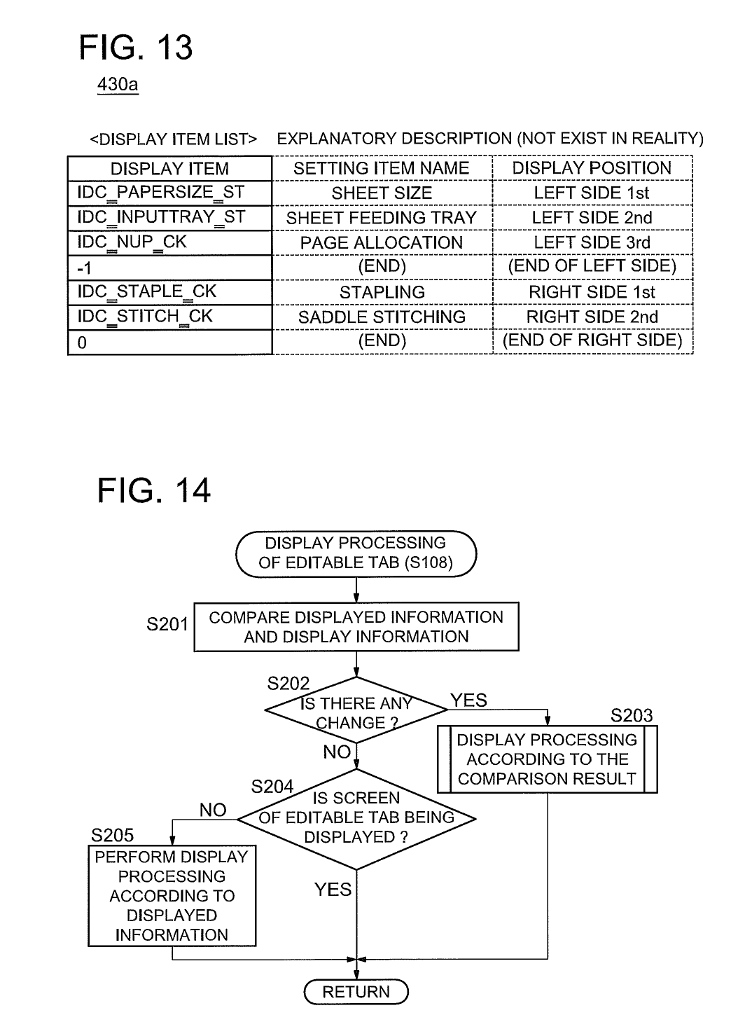

If it is determined in Step S109 that the user has operated to edit the item to be registered in the editable tab (S109: YES), the display item list is updated (S110), and the operation goes back to Step S108. The display item list is a display item information list that indicates which item of the items held by the fixed tab should be displayed on the editable tab screen (FIG. 13).

In Step S106, a decision is made to see whether or not the user has operated to add an item to be registered in the editable tab. If it is determined that the user has not operated to add an item to be registered in the editable tab (S106: NO), and the operation proceeds to Step S111.

If it is determined in Step S106 that the user has operated to add an item to be registered in the editable tab (S106: YES), the display item list is updated (S107), and the operation goes to Step S111.

The following methods are available to edit the item displayed on the editable tab screen and the display position thereof. One is the method (a) where the item is edited by displaying the edit screen. The other is the method (b) where the setting item is shifted in the vertical and lateral directions or is deleted using the menu displayed by right-clicking on the item inside the editable tab screen. Still another is the method (c) where a setting item is added using the menu displayed by right-clicking on the item inside the fixed tab screen. As described above, clicking on any item out of the setting items provides an instruction to edit all the setting items to which the clicked item belongs.

The following describes the process of editing the item to be registered in the editable tab. The item registered in the editable tab is displayed on the editable tab screen.

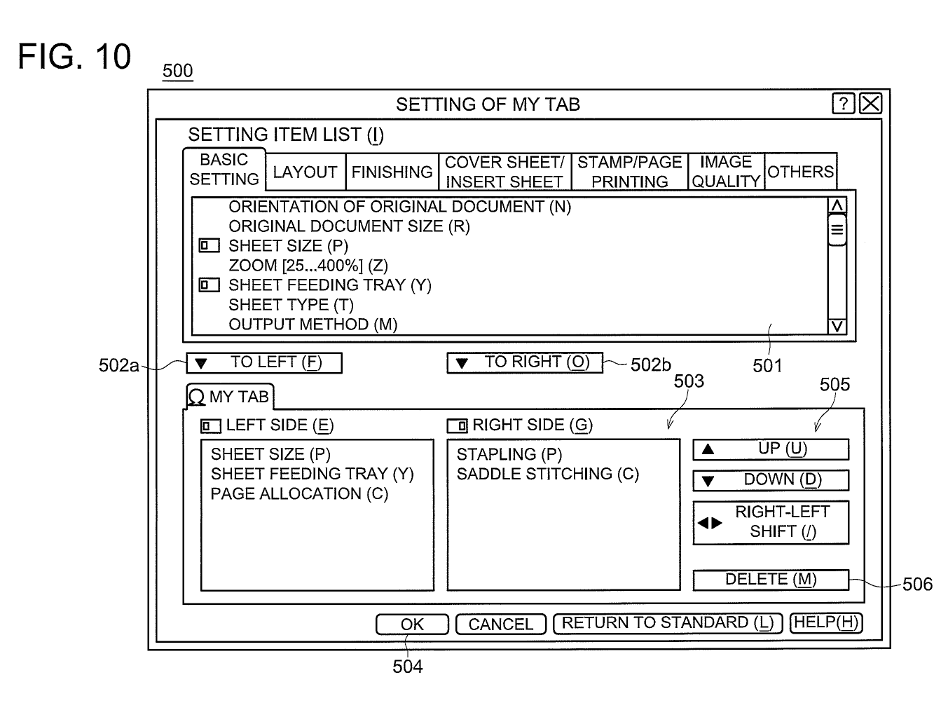

According to the method (a), the edit screen for editing the editable tab screen shown in FIG. 10 is displayed at first. The upper display section 501 of the edit screen 500 displays the list for all the items that can be displayed on the editable tab screen by reference to the editability list 400 (FIG. 7). The editability list 400 to be referenced is a parent list which is made up of a plurality of items and is representative of the setting items as a group responsible for print functions. The parent item of the group is displayed on the upper display section 501 of FIG. 10. (This is also applicable to the lower display section 503).

The lower display section 503 of the edit screen 500 displays a list for the items registered in the editable tab and displayed on the editable tab screen actually. In the initial state, the items originally registered in the editable tab are displayed on the lower display section 503. The items on the editable tab screen can be added or their position can be changed by editing the editable tab.

An item is selected on the upper display section 501 of the edit screen 500 and the “TO LEFT” button 502a is pressed. Then that item is added to the left of the lower display section 503. (In this case, the item is added to the left of the editable tab screen). When the “TO RIGHT” button 502b has been pressed, the item is added to the right of the lower display section 503. (In this case, the item is added to the right of the editable tab screen). Further, the position of the item displayed on the editable tab screen can be changed by pressing the “UP”, “DOWN” and “RIGHT-LEFT SHIFT” buttons 505. Further, the item to be selected can be deleted from the list on the lower display section 503 by pressing the “Delete” button 506.

If the “OK” button 504 is pressed in the final phase, the screen edit instruction to change the display on the editable tab screen is issued according to the information on the lower display section 503.

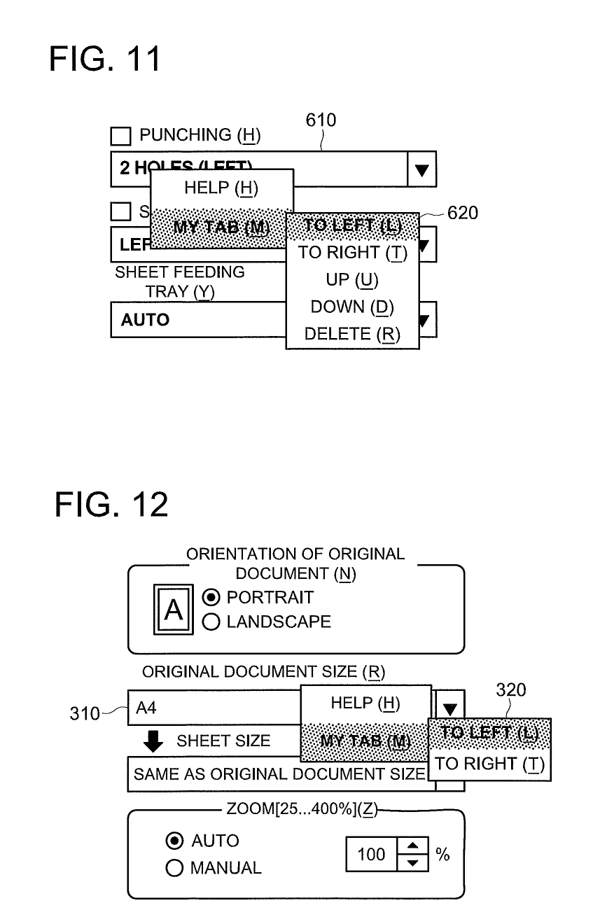

According to the method (b), an instruction is given to edit the screen directly on the editable tab screen, as shown in FIG. 11.

The menu 620 is displayed by right-clicking on the item 610 to be edited. When the user selects any one of the “TO LEFT”, “TO RIGHT”, “UP” and “DOWN” on the menu list, an instruction is given to shift the relevant item to a particular side within the editable tab screen. When “Delete” has been selected, the relevant item can be deleted from the editable tab screen.

If an instruction for the item has been given on the menu 620, reference is made to the group information list 410 (FIG. 8). Then, a step is taken to check the group to which the item belongs, and the ID of the parent item of the group is acquired. In this case, the group information list ensures that the parent item and child item belonging to the function group can be managed as a group, as described above. To be more specific, the group includes one parent item representative of the group, and a plurality of child items. The reference numeral “411” in the group information list 410 of FIG. 8 provides an example of the unity as a group of this list. A screen edit instruction is given to update the display on the editable tab screen according to the acquired ID of the parent item and the instruction from the menu 620.

According to the method (c), an edit instruction of the editable tab screen is given on the screen of the fixed tab, as shown in FIG. 12 (S106).

The menu 320 is displayed by right-clicking on the item 310 desired to be added to the editable tab screen out of the items appearing on the fixed tab screen. The user can give an instruction to add the relevant item to the left of the editable tab screen by selecting “TO LEFT” of the menu list, and to the right of the editable tab screen by selecting “TO RIGHT”. It should be noted that the item to be added is added to the last of the items already displayed.

If the instruction is given to an item on this menu 320, reference is made to the group information list 410 (FIG. 8), similarly to the case of method (b). Then a step is taken to check the group to which the item belongs, and the ID of the parent item of the group is acquired. This is followed by the step of giving a screen edit instruction to update the display on the editable tab screen according to the acquired ID of the parent item and the instruction from the menu 320.

In the present embodiment, the user's instructions for such editing operations as addition, shift or deletion of the item displayed on the editable tab screen are accepted collectively for each group according to the group information held in advance, as described above.

When the screen edit instruction has been given, the display item list is updated, as described above (S107, S110).

FIG. 13 shows an example of the display item list. This display item list 430a also provides the information on the position displayed (arranged) on the editable tab screen. To be more specific, the display item list serves as a display information holding section that holds the display item information for indicating which of the items held by the fixed tab should be displayed on the editable tab screen, and the display position information on the position of the item to be displayed on the editable tab screen.

The display item list 430a contains the IDs of the parent items which are representative of the setting items as a group consisting of a plurality of items, and arranged in the order from the top left of the editable tab screen. The items indicated by the IDs before “−1” on the display item list are placed on the left side of the editable tab screen, and the items indicated by the IDs between “−1” and “0” on the display item list is placed on the right side of the editable tab screen. FIG. 13 shows that items are displayed on the left side of the editable tab screen in the order of “sheet size”, “sheet feeding tray” and “page allocation”, and on the right side of the editable tab screen in the order of “stapling” and “saddle stitching”. Thus, the display on the editable tab screen is updated according to the information of the display item list. To put it more specifically, the child items belonging to the group indicated by the parent item are put together with the parent item, and processing is performed. To put it another way, in the present embodiment, such editing operations as addition, shift and deletion of the items to be displayed on the editable tab screen are performed collectively for each group according to the group information held in advance.

Display processing of the editable tab screen is performed according to the new display item list immediately after the display item list has been updated (S107, S110) if the editable tab screen is currently displayed, or immediately after the display has been changed to the editable tab screen next if the screen of the fixed tab is currently displayed (S108).

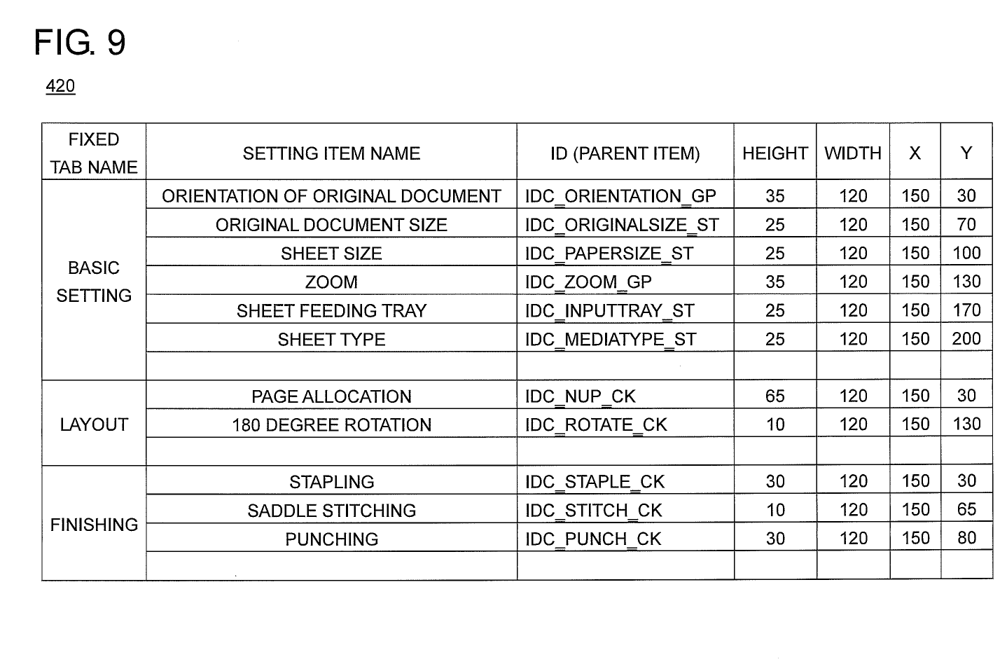

FIG. 9 uses a table to indicate the information of each item according to the item information, editability list, and group information list having been described so far. In the item information table 420 of FIG. 9, in the state of classification into groups, the height, width, X and Y of the setting items indicates the coordinate values when they are displayed on the fixed tab screen. The following description refers to the setting item information of FIG. 9.

The following describes the display processing (S108) of the editable tab screen with reference to the flow chart of FIG. 14.

In the first place, comparison is made between the displayed information of the displayed information table stored in the displayed information holding section 111 and the display information of the display item list (FIG. 13) (S201). In this case, the display information includes the display item information and display position information.

The displayed information table is an information table for the item already displayed on the editable tab screen. To put it another way, the displayed information table includes the displayed information showing what item is displayed at what position on the editable tab screen. This displayed information table is created when the editable tab screen has been displayed. In the first place, the displayed information of the displayed information table is processed as null data.

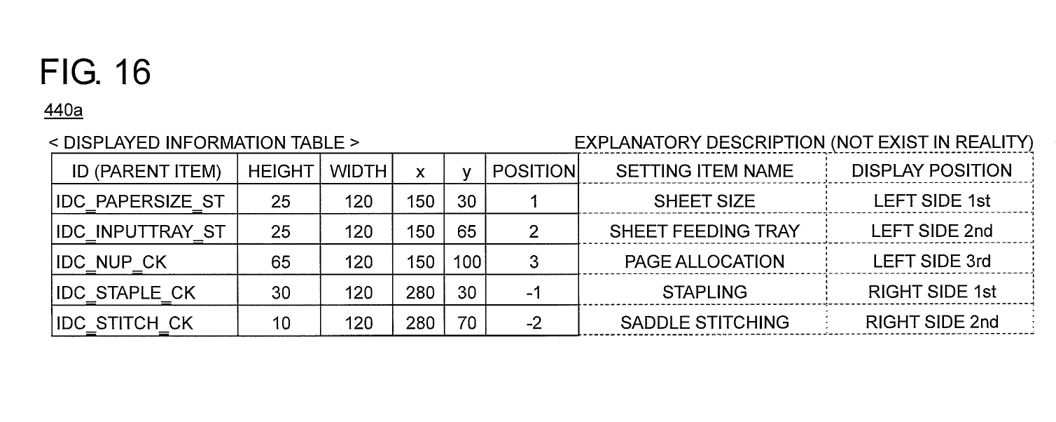

FIG. 16 shows an example of the displayed information table. To put it more specifically, the displayed information of the displayed information table 440a includes the ID of the parent item representing the group made up of a plurality of items, which are constituent elements of the setting items displayed on the editable tab screen, and the information on the longitudinal and lateral dimensions (height and width) of the entire group, display position coordinates (x, y), and position (order of display).

In Step S201, the displayed information is compared with the display information, and a step is taken to determine whether or not there is any change between the two (S202).

If a decision has been made that something has been changed between the displayed information and display information (S202: YES), display processing is performed according to the result of the comparison (S203). The processing in FIG. 14 terminates, and the operation goes back to the flow chart of FIG. 4. In the display processing according to the result of the comparison, a decision on the method for change processing is made to display the editable tab screen according to the result of the comparison, and the editable tab screen is displayed according to the method of change processing having been determined. The details of the display processing according to the result of the comparison will be described later.

If a decision is made that there is no change between the displayed information and display information (5202: YES), a step is taken to determine whether the editable tab screen is currently displayed or not ($204).

If it has been determined that the editable tab screen is not currently displayed (S204: NO), the editable tab screen is displayed according to the displayed information ($205). Processing in FIG. 14 terminates and the operation goes back to the flow chart of FIG. 4. Processing in this Step S205 will be further described later.

If it has been determined that the editable tab screen is currently displayed (S204: YES), the processing in FIG. 14 terminates and the operation goes back to the flow chart of FIG. 4, because the screen including the required items is already displayed. This is illustrated by the example wherein, when the editable tab screen is displayed, the edit screen has been opened from the editable tab screen, but the edit screen is closed without any changes being made.

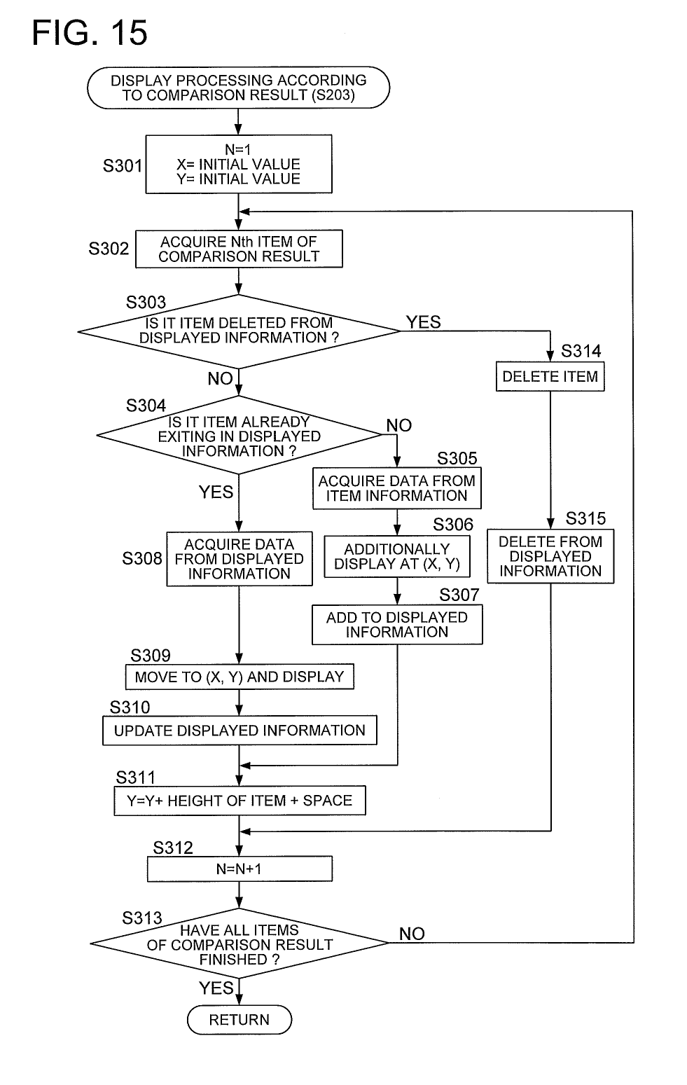

Referring to the flow chart of FIG. 15, the following describes the display processing according to the result of the comparison (S203).

The flow chart of FIG. 15 shows the method of display processing for either the display area on the left of the editable tab screen or the display area on the right of the editable tab screen. The following description is based on the assumption that display processing is performed for the display area on the left of the editable tab screen first and then the display area on the right of the editable tab screen. It is also possible to use the display processing flow chart wherein consideration is given to the displays on both display areas.

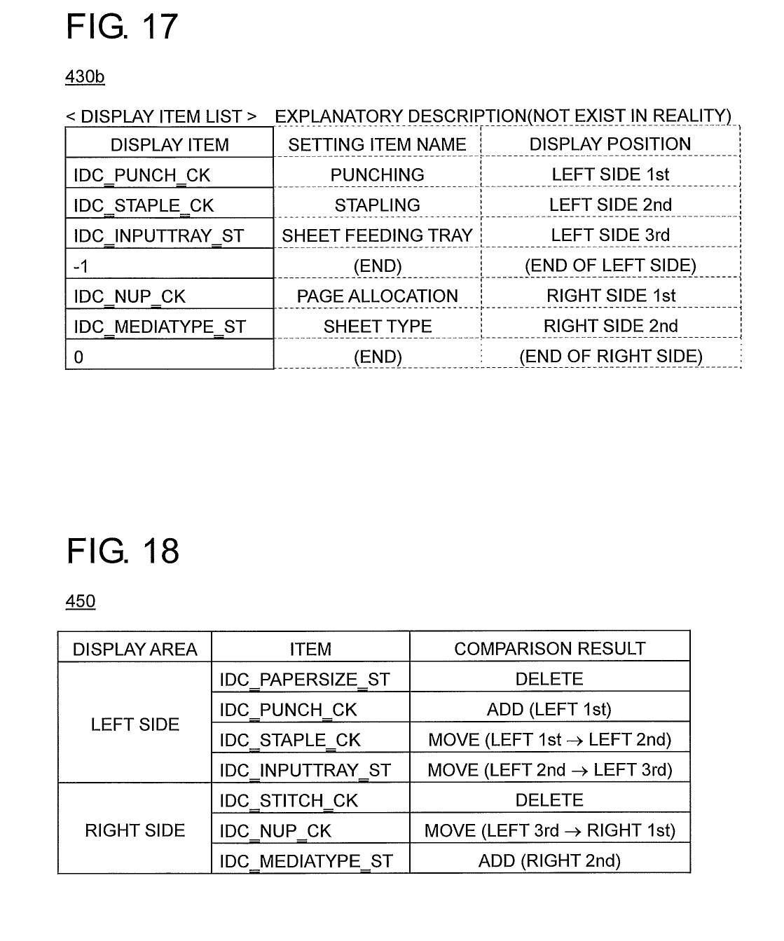

The following two examples will be used for the current description. In the first example, the state of the display item list 430a of FIG. 13 is displayed when the editable tab screen is blank (without any data in the displayed information table). In the second example, after the state of the display item list 430a of FIG. 13 has been displayed, the state of edit to the display item list 430b of FIG. 17 is displayed.

The following describes the first example.

In the first place, the initial coordinate values required to display the first item is given (S301). In this case, the initial coordinate value needed to display the first item in the display area on the left of the editable tab screen is given as X=150, Y=30, in the first place. Although the coordinates are given in pixels, they can also be represented in points and other units. “N” indicates the order in which items appear in the comparison result 450 (FIG. 18) (given separately for the display area on the left and the display area on the right). The initial value thereof is given as N=1. The comparison result 450 is created in Step S201.

This is followed by the step of acquiring the Nth item of the comparison result (S302).

In Step S303, a decision is made to see whether or not the Nth item of the comparison result having been acquired is the item having been deleted from the displayed information.

If it has been determined in Step S303 that the Nth item of the comparison result is not the item having been deleted from the displayed information (S303: NO), a step is taken to determine whether or not the Nth item of the comparison result is already present in the displayed information (S304).

If it has been determined in Step S304 that the Nth item of the comparison result is not present in the displayed information (S304: NO), the operation goes to Step S305.

In the first example, there is no data in the displayed information table at first, and the displayed information is null, and therefore, the decisions in Step S303 and Step S304 are “NO”. The only processing is the addition of setting items.

In Step S305, relevant item data is acquired from the item information (and group information).

In the first example, the first comparison result item is an added setting item, and represents the “IDC_PAPERSIZE_ST” (sheet size). Thus, the “IDC_PAPERSIZE_ST” information is acquired, The “IDC_PAPERSIZE_ST” (sheet size) setting item is composed of the text and combo box item (control), and has a width of 120 and a height of 25. In this case, the coordinate values on the fixed tab to be acquired is not used.

Using the acquired information, the relevant setting item is displayed in addition at the display position defined by the coordinates (X, Y) of the editable tab screen (S306). In this case, the display position of the setting item corresponding to the first comparison result item is defined by the coordinates (150, 30). This ensures that the setting item of the “sheet size” registered in the basic setting tab as a fixed tab is copied onto the editable tab screen and is displayed.

This is followed by the step of adding the information displayed to the displayed information of the displayed information table (S307). Upon termination of the addition to the displayed information, the operation proceeds to Step S311.

In Step S311, the height of the setting item and a space is added to Y. In Step S312, 1 is added to N. The space is 10, but can be changed as required. In this case, Y=30+25+10=65 and N=2.

In Step S313, a step is taken to determine whether or not processing of the last comparison result item in the comparison result has terminated. If processing of the last comparison result item has not terminated (S313: NO), the operation goes back to Step S302.

In this case, processing of the last comparison result item has not yet terminated. Thus, the second comparison result item is processed. This processing of the second comparison result item ensures that the setting item of the “IDC_INPUTTRAY_ST”(sheet feeding tray) is displayed at the coordinates (150, 65). The information displayed is added to the displayed information in the displayed information table.

The above-mentioned processing is repeated, and the display processing of the last setting item of the “IDC_NUP_CK” (page allocation) terminates (S313: YES). This indicates the termination of the processing in FIG. 15.

Similarly, processing is performed to display the setting item in the display area on the right of the editable tab screen. In this case, the initial coordinate values needed to display the first item are given as X=280 and Y=30. The setting items of the “IDC_STAPLE_CK”(staple) and “IDC_STITCH_CK” (saddle stitching) are displayed in the display area on the right of the editable tab screen. Thus, the processing in FIG. 15 terminates.

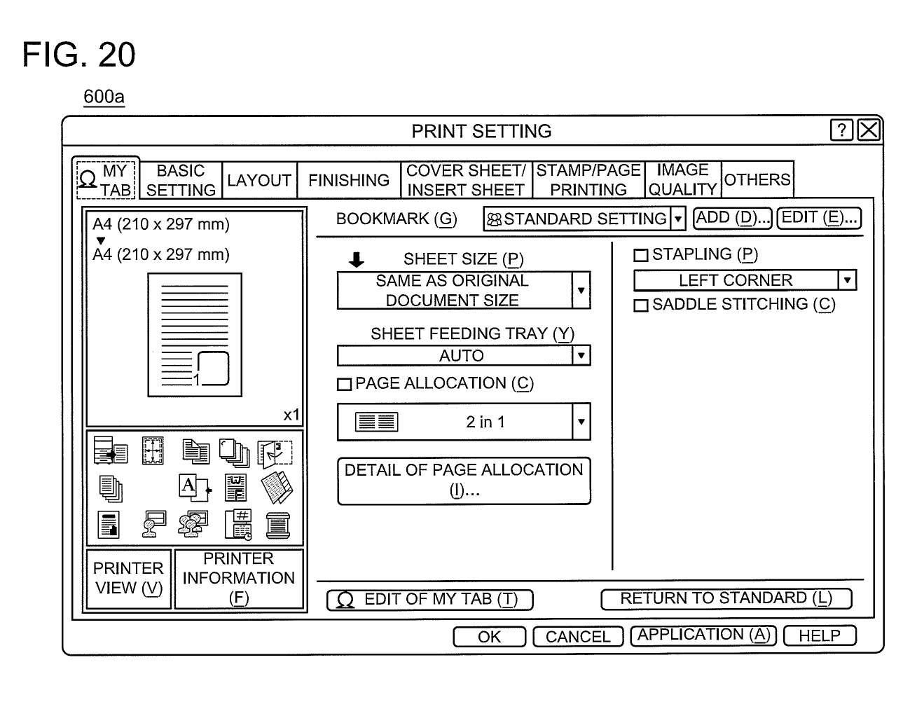

FIG. 20 shows an example of the editable tab screen 600a displaying the state of the display item list 430a of FIG. 13. FIG. 16 described above shows an example of the displayed information table that is created when the editable tab screen 600a of FIG. 20 is displayed. The information on the position in the displayed information table is 1, 2, 3 . . . in that order in the display area on the left, and −1, −2, −3 . . . in that order in the display area on the right. However, this position information is not used in this processing.

The following describes the second example.

As a prerequisite, comparison is made between the displayed information of the displayed information table (FIG. 16) and the display information of the display item list (FIG. 17) (S201), in this case. FIG. 18 shows the comparison result created at this time.

FIG. 18 shows an example of the comparison result. The comparison result 450 shows the result of comparison between the displayed information and display information for each setting item. As shown in FIG. 18, the comparison result that indicates for each setting item whether the setting item is to be deleted, moved, or added.

In the first place, similarly to the case of the first example, the initial coordinate values needed to display the first item are given (S301). The coordinates on the display on the left are X=150 and Y=30 as the initial values. The coordinates on the display on the right are X=280 and Y=30. The space is 10. The appearance order of comparison result items in the comparison result 450 is N=1.

In the comparison result 450 of FIG. 18, the first comparison result item on the left shows the setting items deleted from the displayed information table. The result of the decision in Step S303 is “YES”.

When it has been determined that the Nth item of the comparison result is the setting item having been deleted from the displayed information (S303: YES), the relevant setting item is deleted (S314). In the case of the first comparison result item, the setting item of the “IDC_PAPERSIZE_ST” (sheet size) is deleted from the editable area. The API (Application Program Interface) for deleting the displayed item (control) uses only the ID. This eliminates the need for acquiring other information.

This is followed by the step of deleting the information about the deleted setting item from the displayed information of the displayed information table. In the case of the first comparison result item, the information on the setting item of “IDC_PAPERSIZE_ST” (sheet size) is deleted (S315).

This is followed by the step of adding 1 to N to get N=2 (S312). Since processing of the last comparison result item has not yet terminated (S313: NO), the operation goes back to Step S302, wherein the second comparison result item is processed.

The second comparison result item is “IDC_PUNCH_CK” (punch). This is a newly added setting item. To be more specific, the decisions in Step S303 and Step S304 are “NO”. Similarly to the case of the first example, processing of the addition is performed. In this case, the setting item of the “IDC_PUNCH_CK” is displayed at the coordinates (150, 30) (S305, S306). The displayed information is added to the displayed information in the displayed information table (S307).

This is followed by the step of adding the height of the setting item and a space to Y (S311) and adding 1 to N (S312). In this case, Y=30+30+10=70 and N=3 are obtained. Since processing of the last comparison result item has not yet terminated (S313: NO), the operation goes back to Step S302, and the third comparison result item is processed.

The third comparison result item is the “IDC_STAPLE_CK” (staple), which is the setting item present in the displayed information table (S303: NO and S304: YES).

In this case, the operation goes to Step S308, and data is acquired from the displayed information of the displayed information table (FIG. 16). In this case, the height and width information is acquired from the displayed information.

Using the information already displayed, the relevant setting item is moved to the display position defined by the coordinates (X, Y) of the editable tab screen and is displayed (S309). Here the display position of the setting item corresponding to the first comparison result item is defined by coordinates (150, 70). The API for moving the displayed item (control) uses the information of the ID, coordinate, height, and width. However, the height and width information might not be required, depending on the type of API.

In the case of processing in which the setting item is moved and displayed, the display position (display coordinates) may not be changed. In such a case, a configuration can be arranged such that a step may be taken to determine that there is no need to change the display position and the setting item may not be moved or displayed. Some of the APIs for moving the setting item perform this decision. Using the API that moves and displays the setting item ensures that a quicker display is made, as compared to the case where the setting item normally made up of a plurality of items (control) is deleted, and is added to another position for display. Further, when the setting item is moved, this ensures quick display processing because the depiction data is already developed in the memory and all that is needed is to rewrite the data of the display position.

In the next step, the displayed information of the displayed information table is updated according to the displayed information (S310). To put it more specifically, coordinate values (x, y) and position information are updated. In this case, x=150, y=70, and the position is “2”.

This is followed by the step of adding the height of the setting item and a space to Y (S311) and adding 1 to N (S312). In this case, Y=70+30+10=110 and N=4 are obtained. Since processing of the last comparison result item has not yet terminated (S313: NO), the operation goes back to Step S302, and the fourth comparison result item is processed.

The fourth comparison result item is the “IDC_INPUTTRAY_ST” (sheet feeding tray), which is the setting item present in the displayed information table (S303: NO and S304: YES). Thus, the processing of the move and display is performed, similarly to the case of the setting item for staple described above.

To be more specific, the “IDC_INPUTTRAY_ST” (sheet feeding tray) is moved to the coordinates (150, 110) of the editable tab screen, and is displayed (S308, S309). The displayed information of the displayed information table is updated (S310).

This is followed by the step of adding the height of the setting item and a space to Y (S311) and adding 1 to N ($312). In this case, Y=110+25+10=145 and N=5 are obtained. Since processing of the last comparison result item has terminated (S313: YES), the processing in FIG. 15 terminates.

Similarly, processing is performed to display the setting item in the display area on the right of the editable tab screen. Here, processing of deletion is applied to the setting item of the “IDC_STITCH_CK” (saddle stitching); processing of the move and display is applied to the setting item of the “IDC_NUP_CK” (page allocation); and processing of the addition of display is applied to the setting item of the “IDC_MEDIATYPE_ST” (sheet type). Thus, the processing in FIG. 15 terminates.

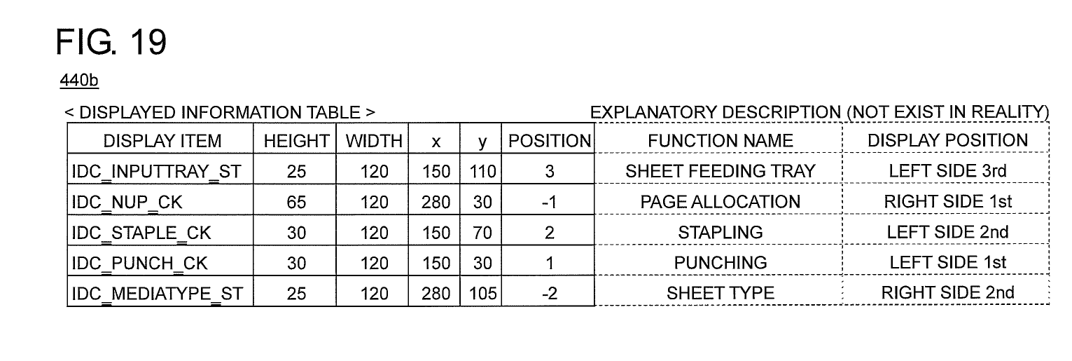

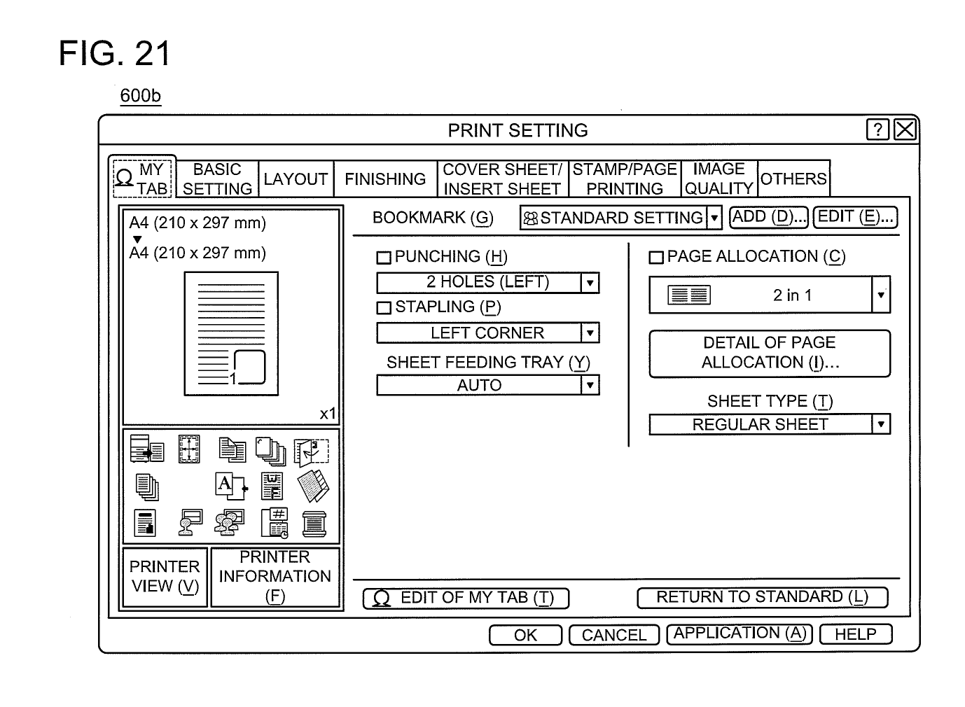

FIG. 21 shows an example of the editable tab screen 600b wherein, after the state of the display item list 430a of FIG. 13 has been displayed, the list has been edited to the display item list 430b of FIG. 17. FIG. 19 shows an example of the updated displayed information table.

The following describes the display processing of the editable tab (S205) when a displayed information table is present at the time of starting the printer driver.

In the display processing of this case, similarly to the case of the first example, information is acquired from item information and the setting item is added. However, since the setting item display position (display coordinate) is acquired from the displayed information of the displayed information table, there is no need to calculate the display coordinate. This contributes to an increase in the display processing speed. Thus, especially for the printer driver in which the initial setting item is provided on the editable tab screen, it is advantageous to incorporate displayed information in advance.

As described above, in the present embodiment, the display information is compared with the displayed information on what items are already displayed at what positions on the editable tab screen, wherein the aforementioned display information includes the display item information on which of the items contained in the fixed tab are to be displayed on the editable tab screen capable of editing the item included therein and the display position information on the position of the item to be displayed on the editable tab screen. If a change has been found out, a step is taken to determine the method of change processing for displaying the editable tab screen according to the result of comparison. The editable tab screen selected by the user is displayed according to the method of change processing based on the result of comparison.

In the present embodiment, if there is a change between the display information and displayed information, the method for change processing such as deletion, shift display, or addition display is determined for each item. The editable tab screen is displayed according to this change processing method.

This arrangement eliminates the need of re-displaying the entire editable tab screen from the beginning, and reduces the time for updating the screen display. This ensures quick display of the editable tab screen that allows the included item to be edited, immediately when there is any updating, with the result that user maneuverability is improved.

Further, in the present embodiment, when the fixed tab holding the fixed item has been selected, the screen of the fixed tab is displayed. The user selects the editable tab in which the item held therein among the items held by the fixed tab can be edited, whereby the editable tab screen is displayed. This arrangement ensures that the editable tab screen in which the held item can be edited is displayed by simple user operation without a sense of incompatibility being given to the user, without losing identification of the location of this item when the items to be set are moved from one screen to another. Thus, this arrangement reduces the operation time of the user and operation error in the item setting work.

In the present embodiment, when there is no change between the display information and the aforementioned displayed information, the editable tab screen is displayed according to the displayed information if the editable tab screen is not currently displayed. Thus, the item display position (display coordinate) is acquired from the displayed information. This procedure eliminates the need of calculating the display coordinate and therefore provides quick display processing.

It is to be expressly understood that the present invention is not restricted to the aforementioned embodiment. The present invention can be embodied in a great number of variations with appropriate modifications or additions, without departing from the technological spirit and scope of the invention claimed.

For example, in the aforementioned present embodiment, the displayed information table is updated after the editable tab screen having been edited is displayed. Without the present invention being restricted thereto, however, it is also possible to arrange such a configuration that the displayed information table can be updated after the processing of editing the items to be registered on the editable tab has terminated. This configuration permits quick display processing when the editable tab screen is opened again, even when only the edit processing is performed without the editable tab screen being displayed immediately.

In the aforementioned embodiment, the display item information showing which of the items held by the aforementioned fixed tab should be displayed on the editable tab screen, and the display position information on the position of the item to be displayed on the editable tab screen are both stored in the display item list. Without the present invention being restricted thereto, however, they can be stored in various forms of storage areas.

Further, the aforementioned embodiment has been described with reference to the item setting device for setting in conformance to the user's operation regarding the items for setting the print conditions. However, the present invention is not restricted thereto. For example, the present invention is also applicable to the item setting device in conformance to the user's operation regarding the items for setting the conditions for other services.

The means and methods for performing various forms of processing in the item setting device of the present embodiment can be implemented by either a special-purpose hardware circuit or a programmed computer. For example, the aforementioned program can be provided by a computer-readable recording medium such as a flexible disk or CD-ROM, or can be provided online through via the network such as the Internet. In this case, the program recorded on the computer-readable recording medium is usually transferred to a storage device such as a hard disk and is stored thereon. The aforementioned program can be provided as independent application software, or can be incorporated in the software of the device as a function of the item setting device.

What is claimed is:

1. An item setting device which conducts setting based on operation of a user, for items which are displayed on a screen which can be switched by selecting a desired tab from a plurality of tabs, the item setting device comprising:
an item information holding section which holds item information relating to display of fixed items of a fixed tab;
a fixed tab display control section for controlling to display a screen of the fixed tab selected by the user by using the item information of the fixed tab;
a display information holding section which holds display information including display item information and display position information, the display item information relating to which items held in the fixed tabs are to be displayed on a screen of an editable tab having the items which can be edited and the display position information relating to display positions of the items to be displayed on the screen of the editable tab;
a displayed information holding section for holding displayed information about which items have been already displayed and which positions on the screen of the editable tab the items have been displayed at;
a display item comparison processing section which compares the display information and the displayed information, and determines a change processing method for displaying the screen of the editable tab based on a result of the comparison if a change is found; and
an editable tab display control section for controlling to display the screen of the editable tab selected by the user according to the change processing method based on the result of the comparison.

2. The item setting device of claim 1,
wherein the display item comparison processing section determines deletion, shift display or addition display for each item based on the result of the comparison.

3. The item setting device of claim 1,
wherein the editable tab display control section controls to display the screen of the editable tab according to the displayed information, if no change is found when comparing the display information with the displayed information and the screen of the editable tab is not currently displayed.

4. The item setting device of claim 1,
wherein the display position information can be edited by the user.

5. The item setting device of claim 1,
wherein the item is for setting a print condition.

6. A computer-readable recording medium which stores a control program for an item setting device which conducts setting based on operation of a user, for items which are displayed on a screen which can be switched by selecting a desired tab from a plurality of tabs, the program making the item setting device implement the steps of:
(a) displaying a screen of a fixed tab selected by the user by using item information of the fixed tab which is stored in an item information holding section which holds the item information relating to display of fixed items of the fixed tab;
(b) determining a change processing method for displaying a screen of an editable tab having the items which can be edited based on a result of the comparison when a change is found by comparing display information with displayed information, the display information being stored in a display information holding section which holds the display information including display item information and display position information, the display item information relating to which items held in the fixed tabs are to be displayed on the screen of the editable tab and the display position information relating to display positions of the items to be displayed on the screen of the editable tab, the displayed information being stored in a displayed information holding section which holds the displayed information about which items have been already displayed and which positions on the screen of the editable tab the items have been displayed at; and
(c) displaying the screen of the editable tab selected by the user according to the change processing method based on the result of the comparison.

7. The computer-readable recording medium of claim 6,
wherein deletion, shift display or addition display for each item is determined based on the result of the comparison in the determining step (b).

8. The computer-readable recording medium of claim 6,
wherein the screen of the editable tab is displayed according to the displayed information in the displaying step (c), if no change is found when comparing the display information with the displayed information and the screen of the editable tab is not currently displayed.

9. The computer-readable recording medium of claim 6,
wherein the display position information can be edited by the user.

10. The computer-readable recording medium of claim 6,
wherein the item is for setting a print condition.

11. A control method for an item setting device which conducts setting based on operation of a user, for items which are displayed on a screen which can be switched by selecting a desired tab from a plurality of tabs, the control method comprising the steps of:
(a) displaying a screen of a fixed tab selected by the user by using item information of the fixed tab which is stored in an item information holding section which holds the item information relating to display of fixed items of the fixed tab;
(b) determining a change processing method for displaying a screen of an editable tab having the items which can be edited based on a result of the comparison when a change is found by comparing display information with displayed information, the display information being stored in a display information holding section which holds the display information including display item information and display position information, the display item information relating to which items held in the fixed tabs are to be displayed on the screen of the editable tab and the display position information relating to display positions of the items to be displayed on the screen of the editable tab, the displayed information being stored in a displayed information holding section which holds the displayed information about which items have been already displayed and which positions on the screen of the editable tab the items have been displayed at; and
(c) displaying the screen of the editable tab selected by the user according to the change processing method based on the result of the comparison.

12. The control method of claim 11,
wherein deletion, shift display or addition display for each item is determined based on the result of the comparison in the determining step (b).

13. The control method of claim 11,
wherein the screen of the editable tab is displayed according to the displayed information in the displaying step (c), if no change is found when comparing the display information with the displayed information and the screen of the editable tab is not currently displayed.

14. The control method of claim 11,
wherein the display position information can be edited by the user.

15. The control method of claim 11,
wherein the item is for setting a print condition.
